(19) United States
(12) Patent Application Publication
(10) Pub. No.: US 2019/0041697 A1
(43) Pub. Date: Feb. 7, 2019

(54) BACKLIGHT AND MODE CONTROL METHOD THEREOF, DISPLAY PANEL AND DISPLAY

(71) Applicants: BOE TECHNOLOGY GROUP CO., LTD., Beijing (CN); K-TRONICS (SUZHOU) TECHNOLOGY CO., LTD., Suzhou (CN)

(72) Inventors: Zhihao Yan, Beijing (CN); Bao Liu, Beijing (CN)

(21) Appl. No.: 16/051,454

(22) Filed: Jul. 31, 2018

(30) Foreign Application Priority Data
Aug. 4, 2017 (CN) 201710662046.3

(51) Int. Cl. G02F 1/1335; G09G 3/32; F21S 4/28

(52) U.S. Cl. CPC G02F 1/133603; F21S 4/28; G09G 3/32

(57) ABSTRACT

A backlight and a mode control method thereof, a display panel, and a display are provided. The backlight includes: a backlight body, the backlight body has a display mode and an illumination mode, luminance of the illumination mode is greater than luminance of the display mode; a switching circuit configured to generate mode information of the backlight body; a detection circuit configured to obtain the mode information generated by the switching circuit; and a control circuit configured to receive the mode information obtained by the detection circuit and drive the backlight body to switch between two display modes based on the mode information obtained by the detection circuit.

### CROSS-REFERENCE TO RELATED APPLICATION

The present application claims a priority of the Chinese patent application No. 201710662046.3 filed on Aug. 4, 2017, which is incorporated herein by reference in its entirety.

### TECHNICAL FIELD

The present disclosure relates to the field of display device technologies, and in particular, to a backlight and a mode control method thereof, a display panel, and a display.

### BACKGROUND

At present, displays on the market are single devices and do not have an illumination function. Although related technologies relate to the display illumination function, only an illumination lamp is mounted on the main body of a display, and illumination is provided by power supply from the display.

It should be noted that additionally adding an illumination device on the display body of a display for illumination does not change the backlight within the display panel, and such structure increases design cost and occupies extra space.

### SUMMARY

A backlight is provided in the present disclosure, including; a backlight body, wherein the backlight body has a display mode and an illumination mode, luminance of the illumination mode is greater than luminance of the display mode; a switching circuit configured to generate mode information of the backlight body; a detection circuit configured to obtain the mode information generated by the switching circuit; and a control circuit configured to receive the mode information obtained by the detection circuit and drive the backlight body to switch between the display mode and the illumination mode based on the mode information obtained by the detection circuit.

Optionally, the backlight body includes a plurality of LED lamps.

Optionally, the backlight body includes a first light bar and a second light bar, the first light bar and the second light bar are both coupled to the control circuit, a first part of the LED lamps is arranged on the first light bar, a second part of the LED lamps is arranged on the second light bar; the backlight body is configured to turn on the first part of the LED lamps on the first light bar in the display mode, or to turn on the first part of the LED lamps on the first light bar and the second part of the LED lamps on the second light bar in the illumination mode.

Optionally, the backlight body further includes a regulator configured to adjust power of the LED lamps, the regulator is coupled to the control circuit and configured to control the power of the LED lamps based on control information of the control circuit.

Optionally, the switching circuit includes a switching button, the detection circuit includes a pressure sensor, and the detection circuit is configured to receive a pressure signal applied by the switching circuit.

Optionally, the switching circuit includes an infrared remote controller, and the detection circuit includes an infrared signal receiver.

A backlight mode control method for controlling the above backlight is further provided in the present disclosure, including: obtaining mode information of the switching circuit through the detection circuit; driving the backlight body to switch between a display mode and an illumination mode based on the mode information obtained by the detection circuit; controlling, by the control circuit, the backlight body to be switched from the illumination mode to the display mode in the case that the mode information is to turn off the illumination mode; and controlling, by the control circuit, the backlight body to be switched from the display mode to the illumination mode in the case that the mode information is to turn on the illumination mode.

Optionally, the backlight mode control method further includes: in the case that the backlight body is powered on, receiving, by the control circuit, the mode information obtained by the detection circuit, and feeding back, by the control circuit, an action result to the detection circuit; comparing, by the detection circuit, the action result fed back by the control circuit with the mode information transmitted to the control circuit, to check whether the action result is the same with the mode information.

A display panel is further provided in the present disclosure, including the above backlight.

A display is further provided in the present disclosure, including the above display panel.

### BRIEF DESCRIPTION OF THE DRAWINGS

FIG. 1 is a schematic diagram of a backlight in some embodiments of the present disclosure;

FIG. 2 is a schematic structural diagram of a position of a switching circuit on a display panel in the case that the switching circuit of the backlight has a structure 1 in some embodiments of the present disclosure;

FIG. 3 is a schematic diagram of a relationship between a detection circuit and a control circuit in a backlight in some embodiments of the present disclosure;

FIG. 4 is a schematic diagram of a relationship between luminance and temperature adjustment of a display in some embodiments of the present disclosure;

FIG. 5 is a schematic structural diagram of a wall-mounted display in some embodiments of the present disclosure;

FIG. 6 is a schematic structural diagram of an upright display in some embodiments of the present disclosure; and

FIG. 7 is a schematic diagram of a backlight in some embodiments of the present disclosure.

### DETAILED DESCRIPTION OF THE EMBODIMENTS

The technical solutions of the embodiments of the present disclosure will be clearly and completely described below in conjunction with the accompanying drawings in the embodiments of the present disclosure. It is obvious that the described embodiments are only a part of the embodiments of the present disclosure, rather than all of the embodiments. All other embodiments obtained by those of ordinary skill in the art based on the embodiments of the present disclosure without creative labor shall fall within the scope of the present disclosure.

Referring to FIG. 1, a backlight is provided in some embodiments of the present disclosure, including:

a backlight body, where the backlight body has a display mode and an illumination mode, luminance of the illumination mode is greater than luminance of the display mode;

a switching circuit configured to generate mode information of the backlight body;

a detection circuit configured to obtain the mode information generated by the switching circuit; and

a control circuit configured to receive the mode information obtained by the detection circuit and drive the backlight body to switch between the two display modes based on the mode information obtained by the detection circuit.

According to some embodiments of the backlight, the backlight body has two display modes, the switching circuit is configured to receive a user's instruction and generate mode information of the backlight body, the detection circuit acquires the mode information from the switching circuit and transmits the mode information to the control circuit, and after receiving the mode information transmitted by the detection circuit, the control circuit drives the backlight body to switch between the two display modes based on the mode information. In the case that the user's instruction indicates that the illumination mode is to be used, the switching circuit generates illumination mode information, the detection circuit acquires the illumination mode information generated by the switching circuit, the control circuit receives the illumination mode information from the detection circuit and then the control circuit drives the backlight body to be switched from the display mode to the illumination mode, thereby starting the illumination mode of the backlight body. Since luminance of the illumination mode of the backlight body is greater than luminance of the display mode, light emitted by the backlight body may be used for illumination. The backlight uses the change of its own internal structure to form two display modes consisting of illumination mode and display mode, and adds an illumination function on the basis of the normal display function of the backlight, thereby realizing the multi functions of the backlight and enhancing the use efficiency of the backlight.

Therefore, the above-mentioned backlight realizes the illumination function by using an internal program, without adding an additional external device, so it is convenient to be used.

In some embodiments of the present disclosure, the backlight body includes a plurality of LED lamps.

It should be noted that the backlight body includes a plurality of LEDs and the like. In the case that the backlight body is in the display mode, some of the plurality of LED lamps emit light; in the case that the backlight body is in the illumination mode, the plurality of LED lamps all emit light.

It should be noted that the light-emitting device in the backlight body is generally a high-brightness light bar, and the high-brightness light bar is composed of LED lamp beads. A common backlight body uses only one light bar. Since the backlight provided by the present disclosure needs to be used for illumination, optionally, the backlight body includes a first light bar and a second light bar, the first light bar and the second light bar are both signal coupled to the control circuit, a part of the LED lamps are arranged on the first light bar, and another part of the LED lamps are arranged on the second light bar. In the case that the backlight body is in the display mode, only the LED lamps on the first light bar are turned on, and in the case that the backlight body is in the illumination mode, the LED lamps on the first light bar and the second light bar are all turned on.

It should be noted that the structure reduces the difficulty of manufacturing the backlight provided by the present disclosure, and may speed up production efficiency and increase output. Moreover, this structure makes the backlight provided by the present disclosure highly fit to the internal construction of the display panel in the related art, and has high applicability.

In some embodiments of the present disclosure, the backlight body further includes a light guide plate that guides a scattering direction of light, and the light guide plate may be used to increase the luminance of the panel to ensure uniformity of luminance. Since light guide plates are divided into a print type and a non-print type. Optionally, a non-print type light guide plate is used.

It should be noted that the non-print method uses a precision grinding tool to add a granular material of different refractivity into propylene material during injection molding of the light guide plate, to directly form dense micro-bumps, which act like dots. In the case that light is incident on diffusion points, a line light source is converted to a plane light source.

In some embodiments of the present disclosure, the backlight body further includes a reflection film that reflects light that has not been scattered into a light conducting region so as to improve light utilization. In some embodiments of the present disclosure, a high-reflectivity reflection sheet that may increase the reflectivity of a tube reflector or bottom reflector is used, which may further improve luminance and energy efficiency without conflicting with other highlighting technologies.

In some embodiments of the present disclosure, a multilayer film reflection sheet composed of a hundred-layer high-reflecting film may achieve a refractivity of 99% to 100% for visible light waves, and reduce reflection loss during cyclic lightening.

In some embodiments of the present disclosure, the backlight body further includes a brightness enhancement film.

In some embodiments of the present disclosure, the brightness enhancement film is a prism film which is a one-layer transparent plastic film. A one-layer prism structure is evenly and neatly covered on the surface of the film, and it may converge light which is emitted by the diffusion sheet and uniformly spreads to various angles into an axial angle to increase axial luminance. A single-layer prism sheet allows light to converge in one direction.

In some embodiments of the present disclosure, a vertical prism film is superimposed on the single-layer prism sheet, light may be converged in two directions, and the total gain of the sheet is increased.

In some embodiments of the present disclosure, the backlight body further includes a regulator configured to adjust power of each of the LED lamps, the regulator is signal coupled to the control circuit and configured to control power of each of the LED lamps according to control information of the control circuit.

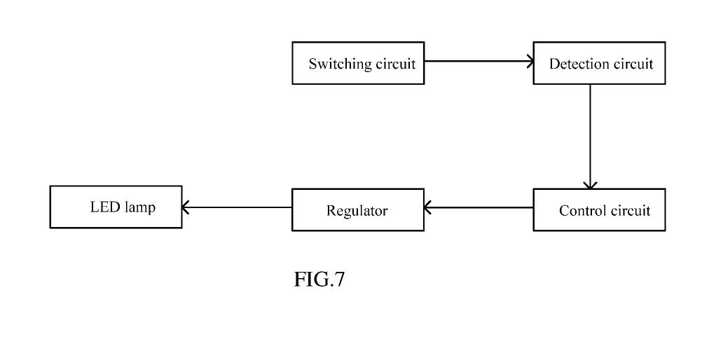

In some embodiments of the present disclosure, the manner in which the regulator is coupled to the control circuit and the LED lamps is as shown in FIG. 7.

It should be noted that the regulator may control the power of each LED lamp according to the control information of the control circuit, thereby realizing the luminance control of the LED lamps.

It should be noted that there are many possibilities for the structure of the switching circuit and the detection circuit, at least one of the following structures:

Structure 1: the switching circuit is a switching button 11, the detection circuit is a pressure sensor, and the detection circuit receives a pressure signal applied by the switching circuit.

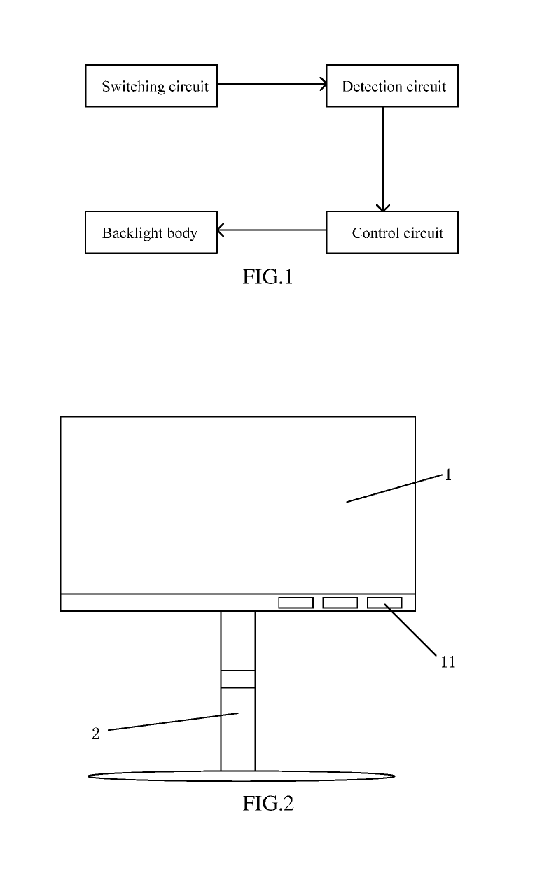

This structure is easy to produce and may reduce manufacturing costs. In some embodiments of the present disclosure. The position of the switching button 11 arranged on the display panel 1 is shown in FIG. 2.

Structure 2: the switching circuit is an infrared remote controller, and the detection circuit is an infrared signal receiver.

Specifically, on the one hand, the structure is convenient for the user to operate, and the portability is strong; on the other hand, the structure occupies a small space, which facilitates miniaturization of the backlight body.

A backlight mode control method for controlling the backlight as described above is further provided in some embodiments of the present disclosure, including:

obtaining mode information of a switching circuit through a detection circuit;

a control circuit for driving the backlight body to switch between two display modes based on the mode information obtained by the detection circuit, controlling the backlight body to be switched from an illumination mode to a display mode in the case that the mode information indicates that the illumination mode is to be turned off, and controlling the backlight body to be switched from the display mode to the illumination mode in the case that the mode information indicates that the illumination mode is to be turned on.

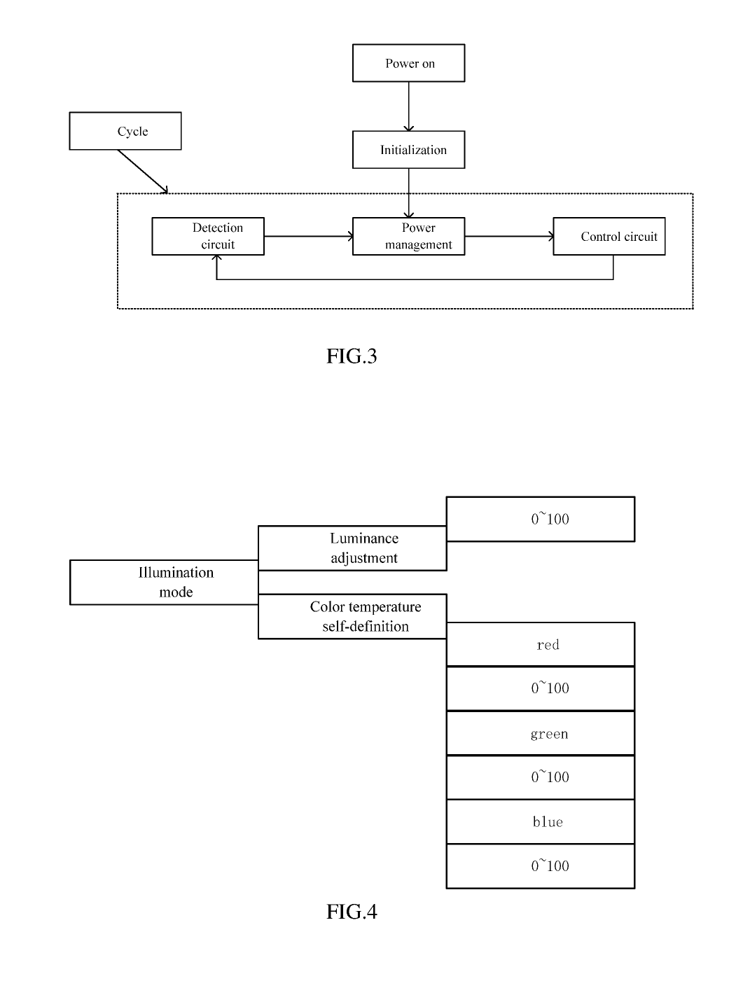

In some embodiments of the present disclosure, please referring to FIG. 3, after the backlight body is powered on, the control circuit receives in real time the mode information obtained by the detection circuit, and feeds back an action result to the detection circuit; the detection circuit compares the feedback information of the control circuit with the mode information transmitted to the control circuit to check if they are the same.

It should be noted that the relationship between the detection circuit and the control circuit forms a cyclic program. In the case that the display is turned on, whether in a standby black screen state or a signal access display state, if the switching circuit is triggered, the backlight body is converted into the illumination mode and may realize the illumination function; in the case that the switching circuit is clicked again, the display mode is resumed, and the illumination mode is turned off.

A display panel including the above backlight is further provided in some embodiments of the present disclosure.

A display including the above display panel is further provided in some embodiments of the present disclosure.

Specifically, in the power-on state of the display, whether in the standby black screen state or the signal access display state, if the switching circuit is triggered, the display is converted into the illumination mode and may realize the illumination function; in the case that the switching circuit is clicked again, the display mode is resumed, and the illumination mode is turned off.

In some embodiments of the present disclosure, a functional function is added, and the main role of this functional function is as follows:

a processor of the display throws out a white menu by drawing a pattern, and spreads same across the entire display for illumination.

In some embodiments of the present disclosure, the display may further realize light conversion in luminance, temperature, and a plurality of colors, and there is a menu bar on the display screen for selecting the light color and luminance of the display in the illumination mode.

It should be noted that the color of the display is usually composed of three primary colors of red, green and blue. By controlling the degree of inversion of liquid crystals in the display, the output intensity of the three colors of red, green and blue may be controlled, and thus, various color outputs may be realized, for example, warm light may be outputted if reducing the output of blue light.

It should be noted that liquid crystal material is an organic compound, and the main element of liquid crystal molecules is carbon (C), which has a slender rod shape. If a voltage is applied to the rod-shaped liquid crystal molecules, an “electric dipole moment” is generated, that is, the positive and negative voltages form pairs of special forms at a certain distance, and this effect will affect and change the magnitude and direction of the electric field of liquid crystal molecules.

It is precisely because of the electric dipole moment that in the case that a voltage is applied to the liquid crystal molecular layer, positive and negative electrodes are generated inside liquid crystal molecules, and then begin to affect the magnitude and direction of an external electric field, thereby changing the traveling direction of the liquid crystal molecules. After the power supply is stopped, the positive charge of the liquid crystal molecules advances toward the negative charge, and the negative charge advances toward the positive charge, which also changes the arrangement direction of liquid crystal molecules.

Based on the above principle, the display in some embodiments of the present disclosure calls an internal program, and sends an instruction through a chip to change the voltage applied to the liquid crystal, thereby causing the liquid crystal to invert and changing the light transmittance of the liquid crystal. In this way, the light transmittance of one of the red, green, and blue colors may be changed to achieve various color temperatures required for illumination of the display in some embodiments of the present disclosure. Referring to FIG. 4, the blue color in the menu bar is adjusted from 100 to 0, then the liquid crystal becomes upright, and thus light may not pass through. Because blue light may not pass through, the display in some embodiments of the present disclosure becomes to display a yellow screen. In this way, adjusting the red, green, and blue colors separately may achieve the illumination effects of the plurality of colors of the display in some embodiments of the present disclosure.

Moreover, the display in some embodiments of the present disclosure may change the brightness and darkness of the illumination mode as a function of luminance adjustment. For example, please continue to refer to FIG. 4, the luminance in the menu is adjusted from 100 to 0, then the liquid crystal becomes upright after inversion, and thus light may not pass through. Since various lights may not pass through, the display screen provided by the present disclosure will be blackened.

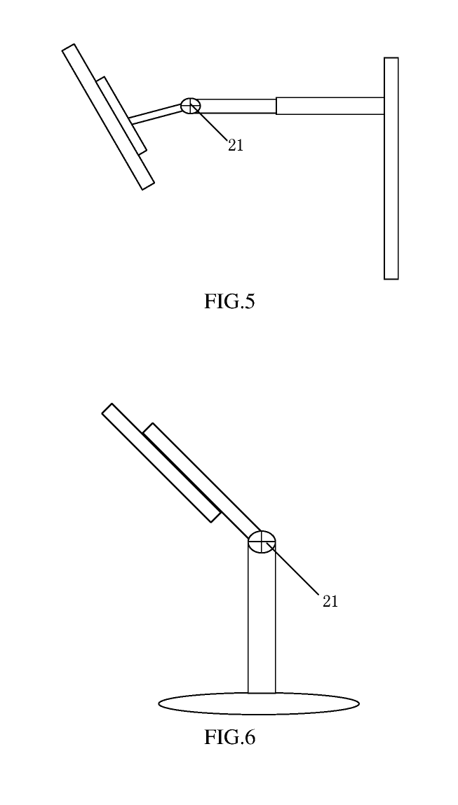

It should be noted that, with reference to FIG. 5, the display in some embodiments of the present disclosure may be wall-mounted; or, referring to FIG. 6, the display in some embodiments of the present disclosure may be upright.

In some embodiments of the present disclosure, a support rod 2 supporting the display screen is provided with a rotating shaft 21 to allow the display screen to be rotatable relative to the base.

In some embodiments of the present disclosure, the support rod 2 supporting the display screen is of a telescopic structure so as to satisfy different display height requirements of users.

Obviously, those skilled in the art may make various modifications and variations to the embodiments of the present disclosure without departing from the spirit and scope of the disclosure. Thus, if modifications and variations of the present disclosure fall within the scope of the claims of the present disclosure and equivalent technology thereof, the present disclosure is also intended to include these modifications and variations.

What is claimed is:

1. A backlight, comprising;
a backlight body, wherein the backlight body has a display mode and an illumination mode, and luminance of the illumination mode is greater than luminance of the display mode;
a switching circuit configured to generate mode information of the backlight body;
a detection circuit configured to obtain the mode information generated by the switching circuit; and
a control circuit configured to receive the mode information obtained by the detection circuit and drive the backlight body to switch between the display mode and the illumination mode based on the mode information obtained by the detection circuit.

2. The backlight according to claim 1, wherein the backlight body comprises a plurality of LED lamps.

3. The backlight according to claim 2, wherein the backlight body comprises a first light bar and a second light bar, the first light bar and the second light bar are both coupled to the control circuit, a first part of the LED lamps is arranged on the first light bar, and a second part of the LED lamps is arranged on the second light bar; and
wherein the backlight body is configured to turn on the first part of the LED lamps on the first light bar in the display mode, or to turn on the first part of the LED lamps on the first light bar and the second part of the LED lamps on the second light bar in the illumination mode.

4. The backlight according to claim 2, wherein the backlight body further comprises a regulator configured to adjust power of the LED lamps, the regulator being coupled to the control circuit and configured to control the power of the LED lamps based on control information of the control circuit.

5. The backlight according to claim 1, wherein the switching circuit comprises a switching button, the detection circuit comprises a pressure sensor, and the detection circuit is configured to receive a pressure signal applied by the switching circuit.

6. The backlight according to claim 1, wherein the switching circuit comprises an infrared remote controller, and the detection circuit comprises an infrared signal receiver.

7. A backlight mode control method for controlling the backlight according to claim 1, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

8. The backlight mode control method according to claim 7, further comprising:
with the backlight body powered on, receiving, by the control circuit, the mode information obtained by the detection circuit, and feeding back, by the control circuit, an action result to the detection circuit;
comparing, by the detection circuit, the action result fed back by the control circuit with the mode information transmitted to the control circuit, to check whether the action result is the same with the mode information.

9. A backlight mode control method for controlling the backlight according to claim 2, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

10. A backlight mode control method for controlling the backlight according to claim 3, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

11. A backlight mode control method for controlling the backlight according to claim 4, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

12. A backlight mode control method for controlling the backlight according to claim 5, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

13. A backlight mode control method for controlling the backlight according to claim 6, comprising:
obtaining mode information of the switching circuit through the detection circuit;
driving the backlight body to switch between the display mode and the illumination mode based on the mode information obtained by the detection circuit;
controlling, by the control circuit, the backlight body to be switched from the illumination mode to the display mode in response to the mode information being to turn off the illumination mode; and
controlling, by the control circuit, the backlight body to be switched from the display mode to the illumination mode in response to the mode information being to turn on the illumination mode.

14. A display panel comprising the backlight according to claim 1.

15. A display comprising the display panel according to claim 14.
